(19) United States
(12) Patent Application Publication
(10) Pub. No.: US 2006/0136292 A1
(43) Pub. Date: Jun. 22, 2006

(54) Collection of data associated with an advertisement

(76) Inventors: Nina Bhati, Mountain View, CA (US); Nicholas Lyons, Sunnyvale, CA (US); Rakhi Rajani, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/017,768

(22) Filed: Dec. 22, 2004

(51) Int. Cl. G06Q 30/00

(52) U.S. Cl. 705/14

(57) ABSTRACT

An advertisement comprises a plurality of features and a plurality of machine readable feature identifications. Each feature is associated with at least one of the plurality of machine readable feature identifications.

### TECHNICAL FIELD

The technical field relates to an advertisement. More particularly, the technical field relates to an advertisement comprising a plurality of features and a plurality of machine readable feature identifications.

### BACKGROUND

Conventional advertisements usually provide static and sometimes outdated information to a reader. A person who views a magazine advertisement, for example, typically views printed information that was created weeks or even months before the person viewed the advertisement. Once printed, the content cannot be modified or updated for the reader. In addition, conventional printed advertisements are a one-way medium because the reader receives only static content from the advertisement. There is no direct mechanism by which the reader can request additional information by reading the static content. Nor is there a means of customizing a static advertisement, such as customizing for a specific location, a single user, a class of users, or for recent events.

Advertisers try to determine the effectiveness of their advertisements in order to improve their advertisements, which ultimately may improve the sales of the products or services being advertised. However, it is difficult to measure the effectiveness of a static advertisement, such as a printed advertisement. For example, if an advertisement is printed in a magazine, there is usually no way to determine whether a reader of the magazine even notices the advertisement. The reader may only be interested in a particular article and thus may never see the advertisement. In addition, many advertisements are full of different types of information. For example, an advertisement for a pair of jeans may show a person wearing a particular shirt, jacket, shoes, and jewelry in addition to the jeans. There is no effective way to determine whether the reader is more interested in the jeans or one or more other features in the advertisement or whether a reader has shown any interest in the advertisement.

Focus groups may be used to collect feedback from viewers of the advertisement. However, the focus groups provide a very limited amount of feedback. Monitoring services, such as provided by AC Nielsen and other companies, may be used to determine the number of readers purchasing a magazine containing an advertisement or viewers viewing a television show with product placement or including a particular commercial. However, these monitoring services may not provide adequate information for determining the extent to which an advertisement or a portion of an advertisement actually engaged the readership, as one measure of the effectiveness of the advertisement on the readership.

### SUMMARY

An embodiment of an advertisement includes a plurality of features and a plurality of machine readable feature identifications, each feature being associated with at least one of the plurality of machine readable feature identifications.

### BRIEF DESCRIPTION OF THE DRAWINGS

Embodiments are illustrated by way of example and not limitation in the accompanying figures in which like numeral references refer to like elements, and wherein:

FIG. 1 shows a general network diagram showing a high-level architecture according to an embodiment;

FIG. 2A shows a system for collecting information about a feature of an advertisement according to an embodiment;

FIG. 2B shows an apparatus for reading a feature ID according to an embodiment;

FIG. 2C shows an advertisement comprising a plurality of features, each feature having an RFID tag with a corresponding feature ID, according to an embodiment;

FIG. 3 shows a system for receiving a request for information, and collecting, analyzing and serving data associated with a feature ID according to an embodiment;

FIG. 4 shows a system for creating records including predetermined information and event information according to an embodiment;

FIG. 5 shows a system for receiving a feature ID and creating a record including the feature ID and event information according to an embodiment;

FIG. 6 shows a flowchart for creating a record including the feature ID according to an embodiment;

FIG. 7 shows a flowchart for creating a record including information associated with a feature ID and a user identification (user ID) according to an embodiment;

FIG. 8 shows a flowchart representing a method of determining the effectiveness of an advertisement according to an embodiment;

FIG. 9 shows a flowchart for identifying and transmitting information associated with a feature ID according to an embodiment; and

FIG. 10 shows a computer system for providing data associated with a feature ID according to an embodiment.

### DETAILED DESCRIPTION OF THE EMBODIMENTS

For simplicity and illustrative purposes, the principles of the embodiments are described. However, one of ordinary skill in the art would readily recognize that the same principles are equally applicable to, and can be implemented with variations that do not depart from the true spirit and scope of the embodiments. Moreover, in the following detailed description, references are made to the accompanying figures, which illustrate specific embodiments.

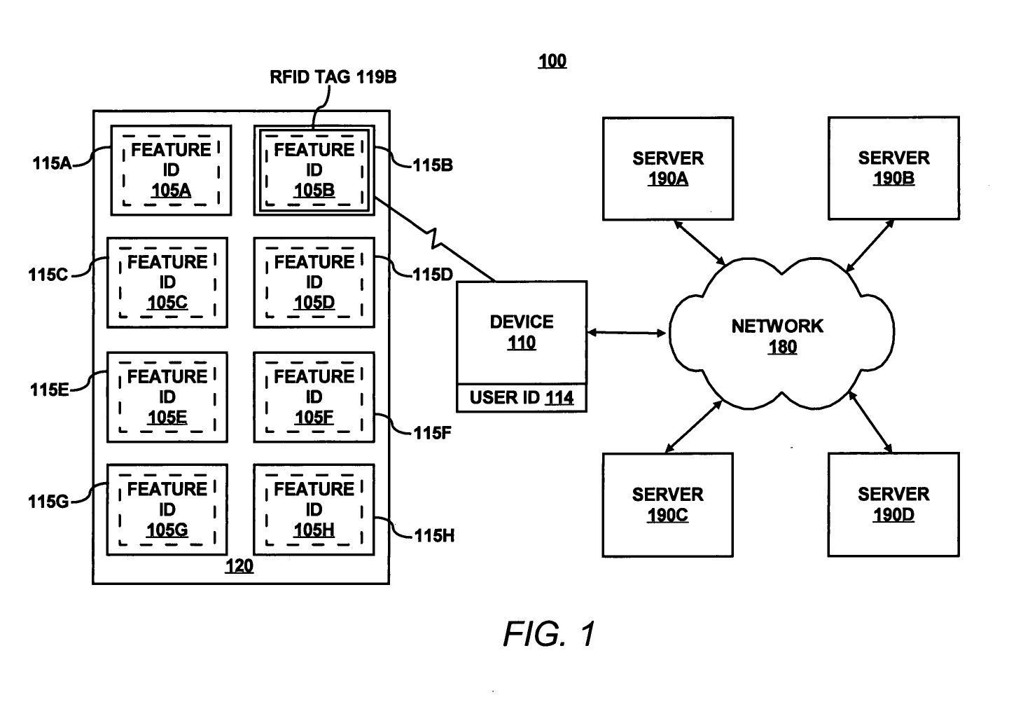

FIG. 1 illustrates a system 100 including a device 110 and a plurality of servers 190, such as 190A, 190B, 190C and 190D, connected via a network 180. According to an embodiment, the advertisement 120 includes a plurality of features 115A-115H and a corresponding plurality of feature IDs 105A-105H. As shown, the feature 115A has the corresponding feature ID 105A, the feature 115B has the corresponding feature ID 105B, and so forth. A feature, such as the feature 115A, may be associated with a feature ID, such as the feature ID 105A, such that the feature ID may be located within, on, over, beneath, around, proximal to, adjacent to, or in any other manner associated with the feature. A feature of an advertisement may also include one of a plurality of feature IDs. For example, one of a plurality of feature IDs may be embedded in a feature of an advertisement. In addition, the feature IDs 105A-105H may include any type of machine readable code.

The advertisement 120 may include, for example, a printed advertisement, an electronic advertisement, or another type of advertisement. For instance, the advertisement 120 may include a printed advertisement for an automobile in a newspaper, book, poster, or magazine, or other printed medium. The advertisement 120 may also include any type of electronic advertisement, including, for example, an advertisement in an electronic display, displayed on a computer monitor, or other advertisement showing a plurality of features.

The device 110 may include a conventional reader, such as a scanner, a reader of a RFID tag, or a reader of another type of transponder. The device 110 may also include a conventional user device, such as a PDA (personal digital assistant), a cellular phone, or other handheld device equipped with a reader operable to read a feature ID. The device 110 may include a stationary device, such as a scanner mounted within a store kiosk. In any regard, the device 110 may be programmed with a user identification (user ID) 114, which may be communicated to one or more servers 190, such as the server 190A, via the network 180.

The device 110 reads one or more feature IDs 105A-H. Each feature ID 105A-105H may be read from a radio frequency identification (RFID) tag, label, or other storage medium storing the feature IDs 105A-105H. An RFID tag, such as the RFID tag 119B, is programmed with a unique identification code, for instance an RFID serial number. The unique identification code is used to identify a specific feature that the tag is attached to, and an RFID tag reader is used to retrieve the code from the tag.

An RFID tag, such as the RFID tag 119B, may be affixed to a feature 115A-115H of the advertisement 120. For example, the RFID tag may be printed or affixed directly on a sheet of paper used to create the advertisement 120. The RFID tag may also be embedded in one of the features 115A- 115H. Any reasonably suitable type of invasive or noninvasive technology may be used for embedding one or more RFID tags in a material.

Information stored in the storage medium, such as the RFID tag 119B, may be used to retrieve additional information about a specific feature 115A-115H. For example, the RFID tag 119B may store the unique feature ID 105B that is used to identify the feature 115B. The feature ID 105B may be read by the device 110, which may be operated by a user interested in the feature 115B of the advertisement 120. The feature ID 105B may also be read by a device using any touchpad or peripheral attachment associated with the device 110. In operation, the device 110 transmits the user's request for information to one or more of the servers 190A-190D via the network 180. In turn, the device 110 receives information associated with the feature ID 105B from one or more of the servers 190A-190D.

In other examples, a feature ID may include an Electronic Product Code (EPC), which may be stored in the RFID tag. EPC codes may include a product class identifier as well as a unique identification code. In another example, a feature ID may include Uniform Product Code (“UPC”) symbols. The UPC symbols store the feature IDs in bar code format, and may be used to identify a class of features rather than providing a unique ID for each feature.

Information associated with a feature of an advertisement 120 may also be retrieved and transmitted without using a device 110. For example, a user may read a feature ID of the advertisement 120 directly with his or her own eyes. A system or apparatus may be used to monitor or track the user's eye movements. When the user's eyes scan the feature ID of the advertisement, an eye tracking system may be used to detect and record this activity. Information associated with the feature having the particular feature ID may then be transmitted to a device 110 operated by the user for displaying the associated information.

The information received by the device 110 may include information about one or more of the features 115A-115H, a product being advertised in the advertisement 120, information about the user's friends that used a device to read a feature ID 105A-105H from the advertisement 120, and other types of information described in detail below. The information associated with a feature ID 105A-105H and transmitted to the device 110 may include information or data from any type of information source including, for example, movies, songs, text, graphics, or other media. In one regard, the information may be individually tailored for each user. The system 100 may thus provide personalized, interactive advertising to a user of the device 110.

The network 180 may comprise a communication medium, which may include wired and/or wireless mediums, at its most basic level. It will be apparent to one of ordinary skill in the art that the network 180 may include many other components, such as switches, gateways, etc., as is known in the art, and may include one or more public networks, for instance, the Internet, and/or private networks.

One or both of the amount and type of data to be retrieved by a server 190 and transmitted to the device 110 may be based on one or more selection criteria. The one or more selection criteria may be selected by a user, may include default options and other parameters, may be calculated and the like. Examples of selection criteria include, but are not limited to, bandwidth, available memory capacity of the device 110, cost of data transfer, user preferences of the type of data to be received, and other parameters associated with data transfer and data storage. The information transmitted to the device 110 may also be optimized for speed, cost, and other factors. The associated data to transmit to the device 110, based on one or more selection criteria, may be determined by identifying a threshold of the one or more selection criteria and selecting an amount of associated information, such that the threshold is not exceeded. For example, the amount of data transmitted to the device 110 may be controlled to remain below the available memory space of the device 110.

At least one customization parameter may be used to filter the information transmitted to a user, such as a user of the device 110 receiving information from one or more of the servers 190A-190D. For example, a feature ID is received by one or more of the servers 190A-190D. The server 190A, for instance, may identify a large amount of information associated with the feature ID that may be transmitted to the user. One or more customization parameters may be used to filter the large amount of information for selecting the actual information to be transmitted to the user.

A customization parameter may include any parameter used to customize or tailor the type of information transmitted to a user. Customization parameters may be selected by a user. Customization parameters may include one or more user-selected parameters based on personalized preferences or user-selected choices about the types of information to receive. Customization parameters may also include default options and other parameters and may also be calculated. Customization parameters may be derived from observed user behavior. The observed behavior may be specific to the user requesting the information. The observed behavior may also be based on an aggregate of observed behaviors for different users. Customization parameters may operate to enhance the quality and type of information for the user by tailoring the data delivered.

Customization parameters may be used to customize any type of information selected and transmitted to a user. As an example of a customization parameter, a user may customize the information received based on a personalized preference for obtaining information related to a specific product category. For example, a customization parameter may be a user's preference for organic foods. The device 110 may be used to read a feature ID from an RFID tag or other storage medium provided in an advertisement for produce from a particular grocery store. The server 190A may transmit information to the device 110 for organic produce available from the grocery store.

As another example of using customization parameters, customization parameters may be based upon one or more observed behaviors of a particular user, as opposed to overt action by a user to select a customization parameter. Customization parameters based on observed behaviors may be used by the server 190A to customize the information retrieved and transmitted to the particular user. For example, a device 110 may be used by a particular user to read a tag associated with a light fixture in an advertisement. An observed preference for that particular user is that the user shows interest in brushed steel light fixtures. Thus, based on the observed behavior of that particular user, the server 190A may customize the information retrieved and initially transmit information pertaining to brushed steel light fixtures to the user. Thus, customization parameters may be determined based on observed behaviors of a particular user. Also, customization parameters may be determined based on observed behaviors of a group of users. For example, an aggregated preference for users in the age group of the particular user is that these users prefer brushed steel light fixtures. Thus, the server 190A may initially transmit information pertaining to brushed steel light fixtures to the user. The type of information retrieved by one or more of the servers 190 and transmitted to the cellular phone 210, for example, may also be customized according to other factors, user preferences or options.

According to another embodiment, predictive techniques may be used to determine the customization parameters to control the amount of data transmitted to a user. In one example, predictions may be based on a particular user's observed behavior. In this example, the authentic or actual behavior of the particular user may be observed, captured, analyzed, and used to retrieve and transmit information to the particular user. In another example, predictions may be based on aggregated behavior observed from different users. In either example, the observed behavior may provide a basis for selecting and transmitting information when the consumer submits future requests for information. Predictive techniques may be used in conjunction with or to derive one or more customization parameters for selecting and transmitting associated data to the cellular phone 210. Customization parameters and/or predictive techniques may thus enhance the quality and type of information provided to a user.

One or more customer-relationship management (CRM) techniques, methods, tools, software, etc., may be used to gather, analyze, and deliver feature-associated information to one or more users and to determine customization parameters. CRM may include, for example, any process, method, system, or tool that operates to enhance one or both of the amount and type of information that is gathered, processed, and delivered to a user, such as a customer, by acquiring data about the user and thus learning about the user. CRM may thus include any approach or system for information retrieval and delivery that is based on learning, for example, using one or more “learning algorithms” to learn about a particular user, such as learning algorithms employed using neural networks or neuroinformatics. Such learning algorithms may be employed by one or more backend services to enhance the type and quality of information delivered to an individual, based on a profile of the individual, observed behavior, changes in observed behavior, or other information gathered that is specific to the particular individual.

CRM techniques may also be based on any other method for gaining information about a particular user. CRM may be used to gather information about customer preferences, buying habits, demographics, age, gender, language preferences, and other information related to an individual. In addition, CRM may be used in enhancing the marketing, sales, and other business activities of a company directed at providing information to one or more consumers or consumer groups.

For example, a provider of information that utilizes one or more servers may utilize one or more CRM approaches to acquire information about a particular user's observed behavior, activity patterns, personalized preferences, or other information pertaining to the behavior and activity of a particular user. CRM methods and tools may also be used to acquire information and learn about the behavior and activities based on the aggregate activities or behavior of one or more groups of individuals. Thus, CRM may enable a provider of information to retrieve and transmit feature-associated information based on information acquired and learned about an individual or a group of individuals. CRM may thus enhance the quality of processes used in delivering information, for example, to consumers or customers seeking information based on a feature of an advertisement.

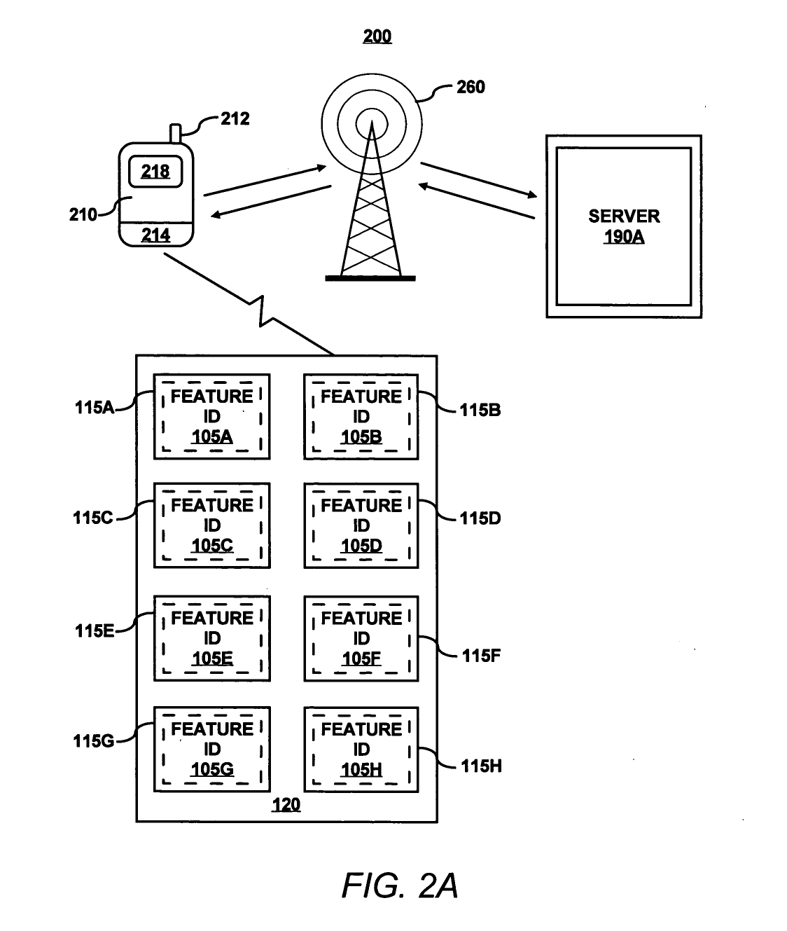

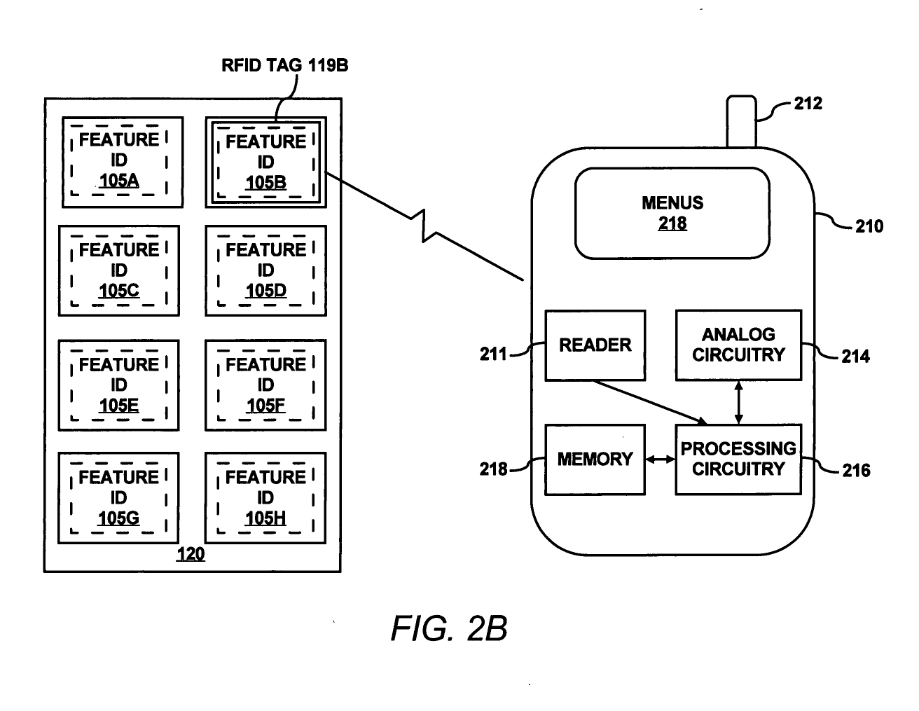

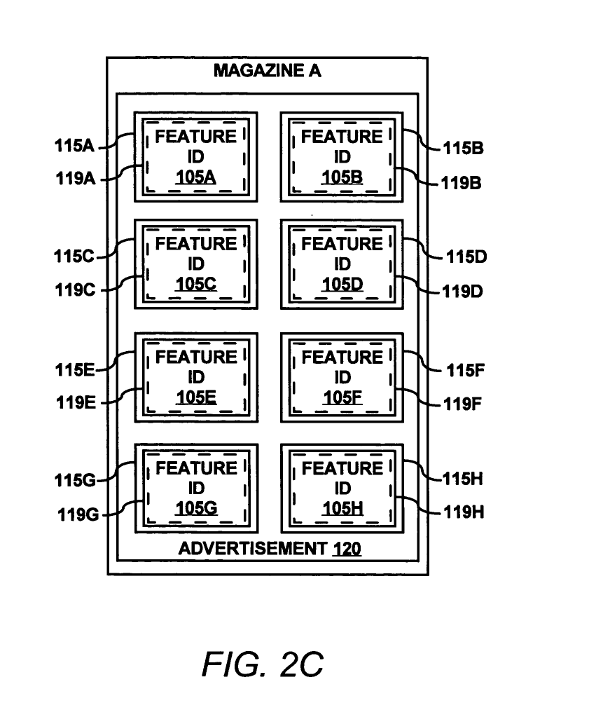

Referring to FIG. 2A, a schematic diagram of a system 200 for providing information associated with the feature 115B of the advertisement 120 is shown. The system 200 includes a cellular phone 210 which, in addition to being operable to perform cellular communication functions, is also operable to read a feature ID 105, such as feature ID 105A-105H. The cellular phone 210 is an example of a type of the device 110 shown in FIG. 1. The cellular phone 210 comprises an antenna 212 for transmitting a signal to, and receiving a signal from, a cellular tower 260. The cellular phone 210 also comprises a screen 218 for displaying information, including data received from the server 190A.

Although not shown in FIG. 2A, one or more of the servers 190, such as the server 190A, may be connected to one or more auxiliary information services, such as one or more public information sources, one or more private information sources, or any combination of public and private information sources or servers linked by one or more networks. Furthermore, one or both of the type and amount of information to transmit to the cellular phone 210 may be determined directly or indirectly by one or more public or private information sources or servers, including one or more of the servers 190 or one or more other decision-making entities.

The cellular phone 210 may also be programmed with a user ID 214. The user ID 214 may be communicated to the server 190A via the cellular tower 260 when a feature ID, such as the feature ID 105B, is read by the cellular phone 210. The cellular tower 260 may communicate with the server 190A indirectly via a network, such as the network 180 shown in FIG. 1. Alternatively, the cellular tower 260 may communicate directly with the server 190A, such as, via a receiver at the cellular tower 260. Although the cellular phone 210 is shown in FIG. 2A, any other device or reader, including for example a handheld or portable device, a mounted device or reader, or other feature ID detection devices may be used to read a feature ID 105, such as the feature ID 105B.

A user may use the cellular phone 210 to submit a request for information associated with the feature 115B having the feature ID 105B. After the cellular phone 210 reads the feature ID 105B, the cellular phone 210 transmits the feature ID 105B to the cellular tower 260. The feature ID 105B may then be transmitted to a node connected to a network, including for example the server 190A. The network may include the Internet and/or a private network. Data that is associated with the feature ID 105B is then identified by the server 190A and transmitted to the cellular phone 210. The system 200, which includes an example of a backend service operable to respond to the user request for information, may provide feature-specific information in response to the user request.

Referring to FIG. 2B, a cellular phone 210 is provided for receiving and displaying data associated with a feature ID 105B on a screen 218. One or more menus may be displayed on the screen 218, and a user may decide to receive additional data associated with the feature 115B having the feature ID 105B. The feature ID 105B may be retrieved from any type of tag, such as the RFID tag 119B. The cellular phone 210 may comprise a reader 211, for example a scanner or camera, for reading a tag such as the RFID tag 119B. The cellular phone 210 may also include analog circuitry 214, processing circuitry 216, and a memory 218. The processing circuitry 216 may generate a signal which may be modulated using the analog circuitry 214. The processing circuitry 216 may also receive the feature ID 105B from the reader 211 and store the data in the memory 218. The cellular phone 210 may further comprise an antenna 212 for transmitting and receiving signals, for instance transmission of a signal to a server 190 after reading the feature ID 105B, or transmission of a user request for additional information based on a menu selection. The cellular phone 210 may be connected to another computing device or a network, such that the device data may be downloaded. The cellular phone 210 may also include the screen 218 for displaying one or more menu options for the user. It should be noted that the cellular phone 210 may include other features not shown and known in the art.

A user of the cellular phone 210 may have one or more user preferences that may be used to determine the amount and/or type of information received from one or more servers 190, such as the server 190A, associated with the feature 115B having the feature ID 105B. The content received from the server 190A may be customized for each user depending on each user's requests for information. Each user may thus manage the content for what is appropriate or desired.

In addition to identifying data that is associated with the feature ID 105B, the server 190A may use at least one selection criteria for optimizing the retrieval and transmission of feature-associated information to the cellular phone 210. As described above, selection criteria may be used to control the amount of data transferred to the cellular phone 210 based on factors such as cost, latency, device specifications, user preferences, etc. For example, the user may select a minimum of associated information to be received if the user is charged based on the amount of data or time of data transfer for transmitting the associated information to the cellular phone 210 from the server 190A.

Determining an amount of associated information using at least one selection criteria may depend on utilization of a tree and leaf architecture. A tree structure may include information stored in the server 190A which may be accessed in response to an input or request for particular information associated with the feature ID 105B. A user interested in finding out information about the feature 115B may use the cellular phone 210 to read the feature ID 105B. The user may then receive the information stored in the server 190A using the cellular phone 210. Within a tree structure, a plurality of leaves may be provided, wherein one of the leaves represents data associated with the feature ID 105B. Once a leaf has been identified within the tree structure, wherein the leaf represents data associated with the feature ID 105B, a point up the tree structure from the leaf may be determined based on one or more selection criteria. Once the selection criteria are identified, the associated information in the tree structure may be retrieved from the highest point in the tree structure to the leaf for the feature ID 105B, wherein the highest point is selected based on the selection criteria. In this manner, information may be retrieved to a certain depth of the tree structure, by retrieving all the data associated with a feature ID 105B from a point in the tree structure to an identified leaf. The information may be communicated to the user, and the user can interact with one or more device applications using the cellular phone 210.

Referring to FIG. 2C, an advertisement 120 in a magazine A is shown comprising a plurality of features 115, such as the feature 115A, the feature 115B, etc., each feature 115 having a corresponding RFID tag 119 with a corresponding feature ID 105, according to an embodiment. For example, the feature 115B of the advertisement 120 may be identified by reading the feature ID 105B from the RFID tag 119B. The advertisement 120 may include, for example, a printed advertisement or electronic advertisement, as discussed above in detail with reference to FIG. 1. The feature ID 105B may be read from the RFID tag 119B which may be embedded or affixed, for example, to the feature 115B.

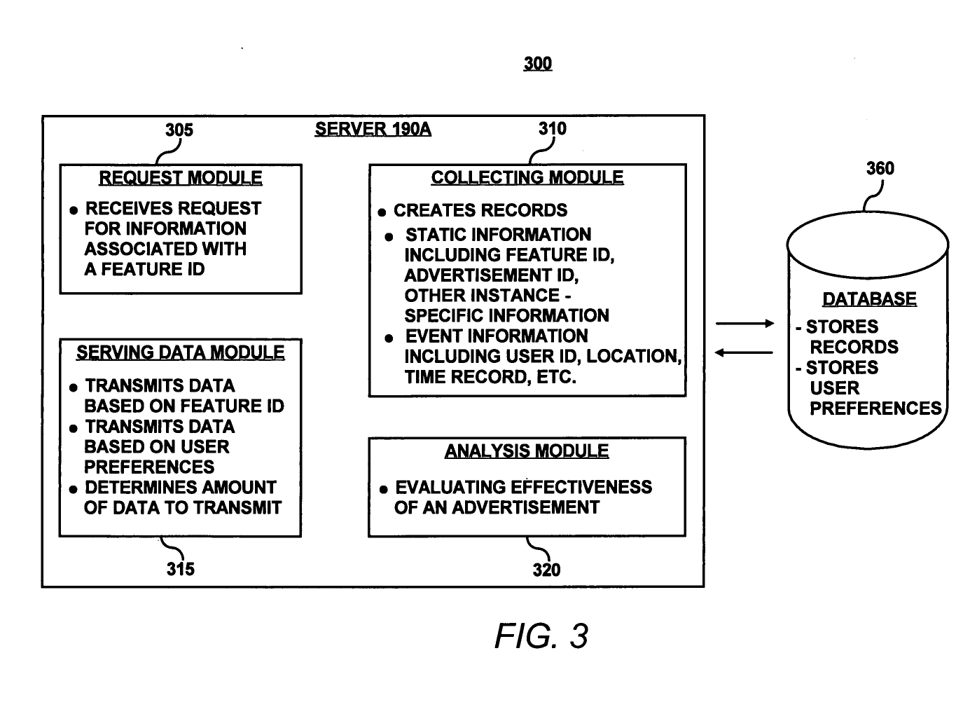

Referring to FIG. 3, according to an embodiment, a system 300 is shown which includes the server 190A and a database 360. The system 300 is an example of a backend service operable to respond to a user request, including a request associated with a feature ID, and to send data associated with the feature ID. Based on one or more customization parameters, the data associated with the feature ID may be customized to the user or the user's device, such as the device 110. The server 190A may provide a reader of printed material, such as a printed advertisement, or a reader of electronic material with opportunities for connecting to more relevant and updated information, which may be time and user-specific. In contrast, a printed advertisement cannot be updated with new information after it is printed and distributed and cannot provide user-specific information.

The server 190A may include a plurality of modules, including for example, a request module 305, a collecting module 310, a serving data module 315, and an analysis module 320. The request module 305 may perform a plurality of functions, including, for example, receiving a user's request for information associated with a particular feature ID, such as the feature ID 105B, associated with the advertisement 120.

The collecting module 310 may implement a plurality of functions, including the creation of records. The records created by the collecting module 310 may include information associated with each instance in which a particular feature ID is read. The information associated with each instance in which a particular feature ID is read may include predetermined information which does not change based on each instance. The predetermined information may include any type of predetermined information, such as, static information. Static information may include, for example, a feature ID, such as the feature ID 105B, or an advertisement ID. The magazine name may be stored in a database as predetermined information, along with the feature IDs for the advertisement 120 and an ID for the advertisement 120.

The records created by the collecting module 310 may also include event information, in addition to the predetermined information discussed above. According to an embodiment, the event information may include specific information that is associated with a particular event in which a feature ID, such as the feature ID 105B, is read. Event information may include such information as a user ID 114, a record of the time in which the feature ID was read, and/or location information, such as the location of a particular magazine having the advertisement 120, city and state information, etc.

For example, the feature 115B having the feature ID 105B may be one of a plurality of features, such as a picture of a digital camera in the advertisement 120 shown in FIGS. 1 and 2. The advertisement 120 may be located in a particular magazine in a particular region, such as Palo Alto, Calif. By way of example, the advertisement 120 located in Palo Alto may have been read by a user using his cellular phone 210 on Oct. 28, 2004 at 10:30 a.m., when the user was reading the magazine in Palo Alto. At the time in which the user used his cellular phone 210 to read the feature ID 105B, the cellular phone 210 was programmed with the user's unique user ID, user ID 114. Thus, when the cellular phone 210 transmits the feature ID 105B to the server 190A, the event information associated with the event that occurred at 10:30 a.m. is used by the collecting module 310 to create a record of the event. Thus, the event information added to the record may include the time, the date, the region location, such as city and state location, the user ID, etc. In another example, one or more programs running in the cellular phone 210 may be used to determine which cellular phone tower that the cellular phone 210 is connected. This information may be used to locate the user of the cellular phone 210 to within a locality having a certain geographic scope, for example, a geographic scope that includes a zip code in an urban area. In another example, the cellular phone 210 may be equipped with one or more location determining capabilities, such as a Global Positioning System (GPS) technology or other location determining technology, which may used to locate a user to a more narrowly focused location.

The records created by the collecting module 310 may also include information on the number of times that a feature of an advertisement was read. For example, information may be collected on the number of “click-through” events recorded for a particular feature of an advertisement, thus providing information on how many times the feature of the advertisement was read.

Information may also be collected on one or more segments of people who used a device to read a feature of the advertisement 120. A segment may include any group or class of people grouped by one or more criteria. Segmentation may include any process or system for classifying or grouping people based on one or more criteria. For example, people may be grouped according to their height. For instance, segment A may include people who are less than six feet tall, and segment B may include people who are taller than six feet. Segmentation may involve the grouping of people according to any number of criteria, for instance, the degree of aversion to taking risks, age groups, location, demographics, buyer behavior, or any other criteria that may be used to classify or group people. Information based on different segments of people may be used, for example, by the collecting module 310. For instance, the records created by the collecting module 310 may include information on one or more segments of people who used a device to read a feature of an advertisement.

The serving data module 315 of the server 190A performs a plurality of functions, including transmitting data associated with a feature ID, transmitting data based on one or more user preferences, and determining an amount of data to transmit based on preselected user preferences. The analysis module 320 may analyze data associated with a feature ID. The analysis module 320 may analyze the data associated with a feature ID to determine the effectiveness of an advertisement, for instance, the advertisement 120. Such analyses may include statistical calculations based on the frequency of access of a feature ID, aggregated statistics based on information associated with each event in which a feature ID was read, and one or more other statistical calculations or other analytical operations. Thus, in one regard, the analysis module 320 may measure and analyze one or more aspects of the effectiveness of the personalized advertising.

The effectiveness of an advertisement may encompass any measure of the extent to which the advertisement reaches one or more users and whether a reader purchases a product or service being advertised, which may include purchases related to any information the reader receives in response to an initial request, etc. Information collected according to the embodiments may be used to determine the advertisement effectiveness, such as the number of people reading the advertisement, the features readers were interested in, and whether any purchases were made based on information transmitted to the user.

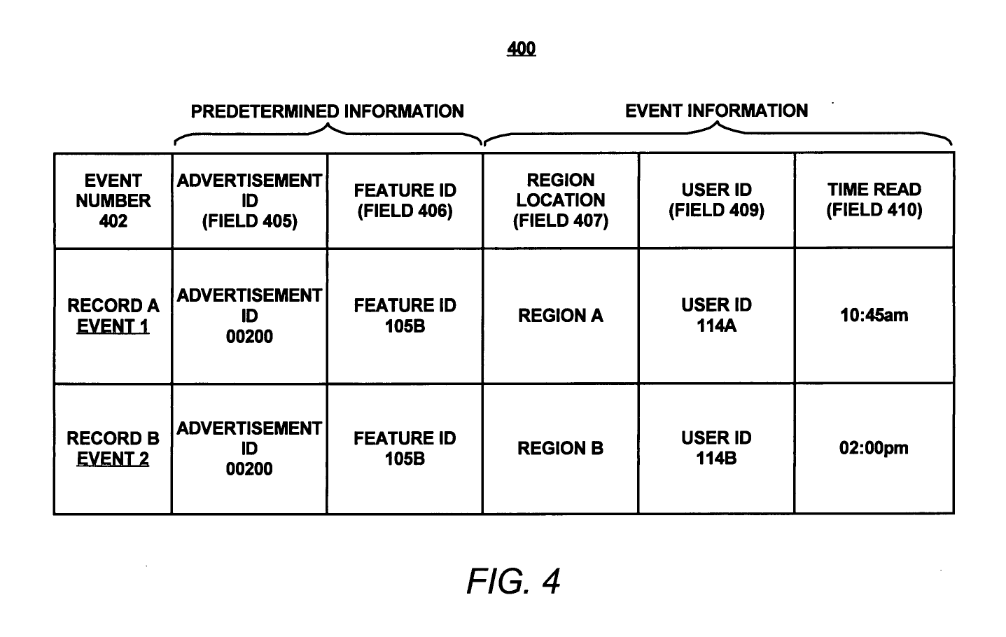

Advertising effectiveness may include, for example, any measure of exposure of the advertisement, readership interest, and/or interaction with an advertisement based on the information collected, for example, by the server 190A shown in FIG. 3 and the collected event information shown in FIG. 4. The effectiveness of an advertisement may also be measured by changes in sales. For example, an advertisement may be placed in a specific region and the sales figures for the products in the advertisement may be determined and analyzed for the specific region where the advertisement appeared. The company, advertiser, or other entity that placed the advertisement may gather information, make conclusions, and/or make business or marketing decisions, for example, based on data collected about the sales data. For example, an advertiser may realize that a certain expenditure on advertising may be correlated with a certain increase in sales. The effectiveness of an advertisement may also be measured by tracking how many people responded to an advertisement by activating the content via a tag, such as an RFID tag. In addition, the effectiveness of the media's exposure may be measured. Sales effectiveness may also be measured and tracked.

The effectiveness of an advertisement may be analyzed based on information collected on the number of “click-through” events recorded for a particular feature of an advertisement. For example, a user may use a device to read an RFID tag associated with a car in an advertisement. The user may receive information about the car and possibly other vehicles from the same manufacturer. The user may then request information about one of the other vehicles. These “click-through” events may be recorded. For example, the location of where the user is and the advertisement from which information is read is recorded. Then subsequent events are recorded, such as the additional information requested. The actual number of click-through events or other events in which the feature of the advertisement was read may be quantized, recorded and analyzed to determine the effectiveness of the advertisement or a particular feature of the advertisement.

An advertiser may want to increase the likelihood that at least one user will read a feature of the advertisement 120. An advertiser may, for example, attempt to motivate or influence a user to read the feature of the advertisement 120 by offering a financial or other incentive to the user. An advertiser may, for example, place a textual message in or near the feature of the advertisement 120 offering a discount on an article of commerce to the user if the feature of the advertisement is read.

The database 360 stores records including the predetermined and event information. The database 360 is operable to receive data from the server 190A and transmit information to the server 190A. The database 360, for example, may receive and store data associated with the records created by the collecting module 310 from the server 190A. The database 360 may also store user preferences, including preferences preselected by a user of the cellular phone 210 (referring to FIG. 2A). User preferences may include preferences about the type and/or amount of information received from the server 190A in response to a request for information associated with a feature ID. For example, after the user of the cellular phone 210 submits the request for information associated with the feature 115B having the feature ID 105B, the server 190A determines the amount and/or type of information to transmit to the cellular phone 210 based on the user preferences stored in the database 360.

FIG. 4 illustrates examples of records that may be stored in the database 360. Records as used herein may include any data structure used to store information. A record may be stored, for example, in a database, a table, etc. Records A and B are shown and correspond to events 1 and 2, respectively. Each event is associated with an occurrence in which a feature ID was read and the corresponding record was created by the collecting module 310 of the server 190A, for example, as shown in FIG. 3. The records may include predetermined information and event information. As shown in FIG. 4, the predetermined information may include an advertisement ID field 405 associated with an advertisement and a feature ID field 406. The event information associated with each event in which a feature ID is read may include, for example, a location information field 407, to indicate the location of a region in which an advertisement is located, a user ID field 409, and a time read field 410, indicating the time in which the feature ID was read. It will be apparent to one of ordinary skill in the art that other fields associated with predetermined information and event information may be included in the records and some of the fields shown may be excluded.

Examples of individual records corresponding to individual events are shown in FIG. 4. For example, record A, representing a record of an event 1, comprises specific information associated with each of fields 405-410, including advertisement ID 00200, feature ID 105B, Region A, etc. Record B, representing a record of a different event referred to as event 2, comprises specific information associated with each of fields 405-410, and corresponding to event 2, including advertisement ID 00200, feature ID 105B, Region B, etc. The information stored in the records may be used by one or more other modules within the server 190A, as discussed above with reference to FIG. 3.

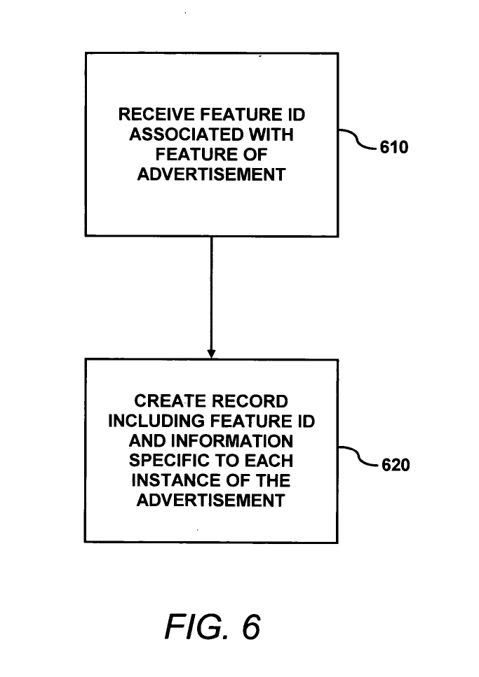

FIG. 5 illustrates two of the same advertisements 120A and 120B located in two different magazines A and B and in two different regions A and B, respectively. Thus, advertisements 120A and 120B each depict the same advertisement, but each is in a different magazine in a different region, for example Los Angeles versus New York City, corresponding to region A and region B, respectively. The feature 115B having the feature ID 105B is present in the advertisement 120A of magazine A located in region A, and also in the advertisement 120B of magazine B located in region B. The device 110 is used to read the feature ID 105B from the advertisement 120A, corresponding to magazine A of region A, and not from the advertisement 120B corresponding to magazine B of region B. The information transmitted to the server 190A by the device 110 includes event information, such as the region location and a user ID, in addition to the feature ID 105B for the corresponding feature 115B of advertisement 120A.

Specifically, the source of the feature 115B having the feature ID 105B, as read by the device 110, is the advertisement 120A of the magazine A in region A, and not the advertisement 120B of the magazine B in region B. After the server 190A receives the feature ID 105B from the advertisement 120A and the user ID, the server 190A creates a record including the feature ID 105B and other predetermined information specific to the instance of the advertisement 120A. The record created by the server 190A also includes event information, such as the region location for the advertisement 120A, the user ID, and the time in which the feature ID was read. As discussed above, with reference to FIG. 3, this information may be used in determining the effectiveness of the advertisement 120A. In addition, the location information and possibly other information in the record may be used to determine the information transmitted back to the user. For example, the user of the device 110 may receive data about products more likely to be of interest to a person in region A rather than region B and associated with the feature 115B or the advertisement 120A.

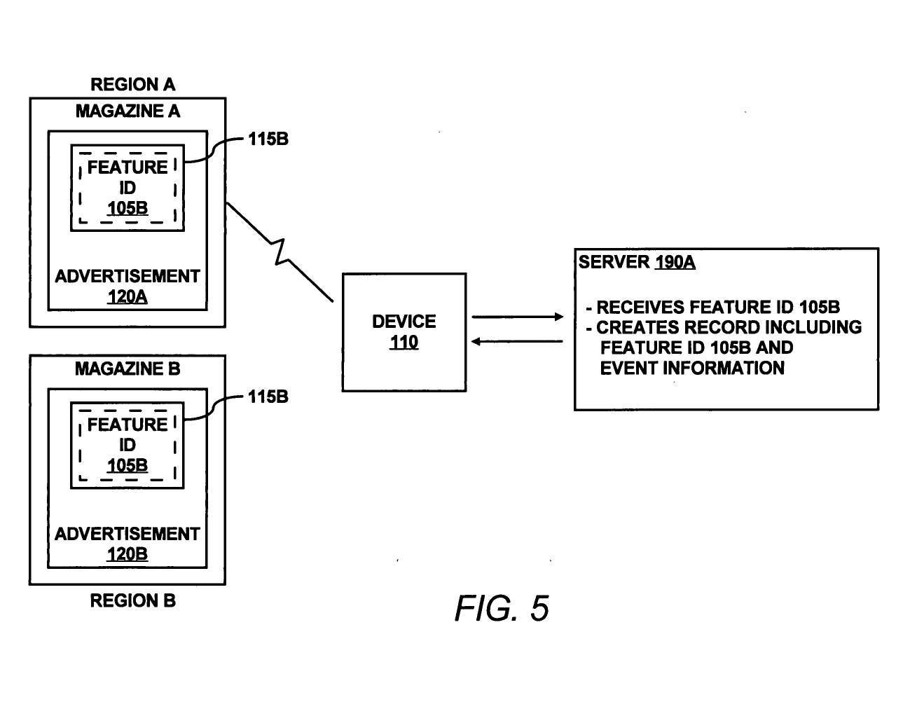

FIG. 6 illustrates a flowchart of a method for creating a record which includes, for example, the feature ID. At step 610, a feature ID, such as the feature ID 105B shown in FIGS. 1 and 2, associated with the feature 115B of the advertisement 120 is received by the server 190A. At step 620, the server 190A creates a record including the feature ID and information specific to each instance of the advertisement 120, such as location of the advertisement, advertisement ID, etc. The information specific to each instance of the advertisement may include the predetermined information associated with an advertisement, such as the unique feature IDs for the advertisement, a unique advertisement ID, etc. The predetermined information, event information and examples of records are described in detail above with respect to FIG. 4.

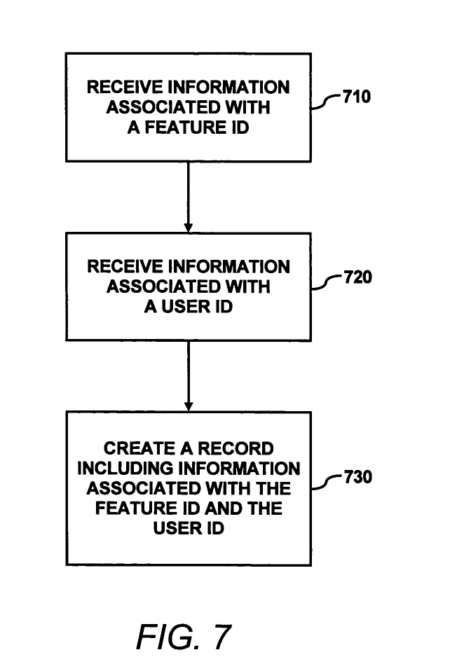

FIG. 7 illustrates a flowchart of a method for collecting data associated with an advertisement, such as the advertisement 120A. At step 710, information associated with the feature ID 105B is received by the server 190A, wherein the feature ID 105B is associated with the feature 115B of the advertisement 120A. At step 720, information associated with the user ID 114, as shown in FIG. 1, is also received by the server 190A. At step 730, a record is created by the server 190A. The record may include information associated with the feature ID 105B and the user ID 114. For example, a user may own a device 110 which stores the user's unique user ID 114. The user may use the device 110 to read the feature ID 105B of a feature 115B in an advertisement 120 in a magazine. The feature 115B may be a specific feature, such as a discrete feature of a house, for example a door, having the feature ID 105B in the advertisement 120 displayed in the magazine. The server 190A thus creates a record of both the feature ID 105B and the user ID 114, which correspond to the user's request for information about the feature 115B from the magazine. The server 190A may also create a record of information associated with the specific instance of the advertisement 120 displayed in the magazine, for example the source, such as a publisher of the magazine, or the unique advertisement ID associated with the magazine.

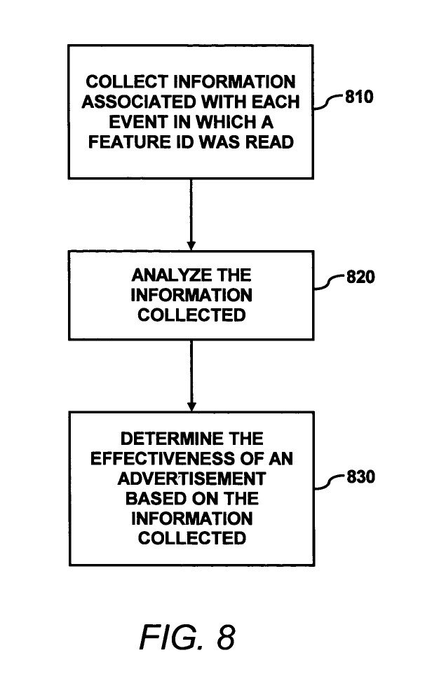

FIG. 8 illustrates a flowchart of a method for determining the effectiveness of an advertisement, such as the advertisement 120A. At step 810, information associated with each instance and event for the advertisement 120A is collected by the server 190. This may include any user and feature IDs received by the server 190 and other associated information. At step 820, the information collected is analyzed by the server 190A. At step 830, the effectiveness of the advertisement 120A is determined based on the information collected. For example, the server 190A may collect information as to the number of events in which the feature ID 105B was read. As discussed above in detail with reference to FIG. 3, the server 190A may also collect information about each event in which the feature ID 105B was read and possibly information about other features in the advertisement 120A. The collected information may then be used to determine the effectiveness of the advertisement 120A. For example, the information may be used to analyze the demographics of the people who used a device 110 to read the feature ID 105B, or analyze individual user profiles, and/or analyze information about the effectiveness of the feature 115B having the feature ID 105B in advertising. The information collected may also be aggregated, such as information on the frequency of access of the feature ID 105B. Statistics may also be compiled for evaluating the effectiveness of the feature 115B having the feature ID 105B.

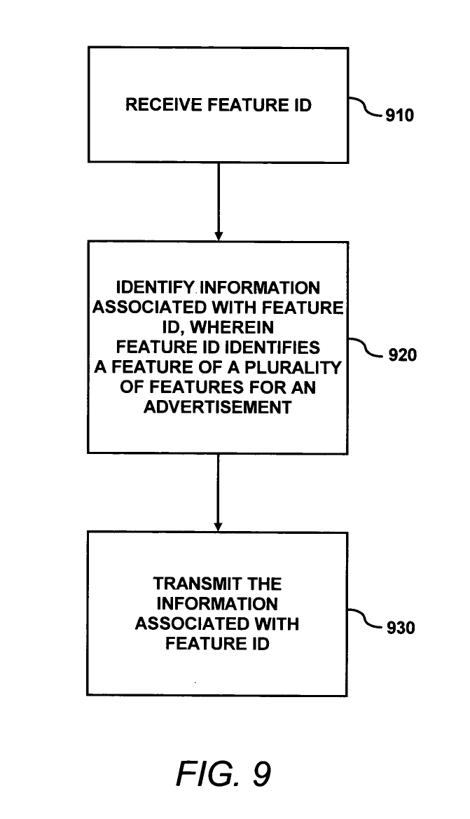

FIG. 9 illustrates a flowchart of a method for identifying and transmitting information associated with a particular feature ID. At step 910, a server, such as the server 190A shown in FIGS. 1 and 2 receives a particular feature ID, such as the feature ID 105B. The feature ID 105B may be one feature ID from among a plurality of distinct feature IDs for the advertisement 120. At step 920, the server 190A identifies information associated with the particular feature ID 105B. For example, the identified information may include information about the feature 105B, a product being advertised in the advertisement 120, information about the user's friends that read a feature of the advertisement 120, and other types of information which may be associated with user preferences. At step 930, the server 190A transmits the identified information to a device initially transmitting the feature ID 105B, such as the device 110. This mechanism may provide real-time customization and feedback based on the transmitted information.

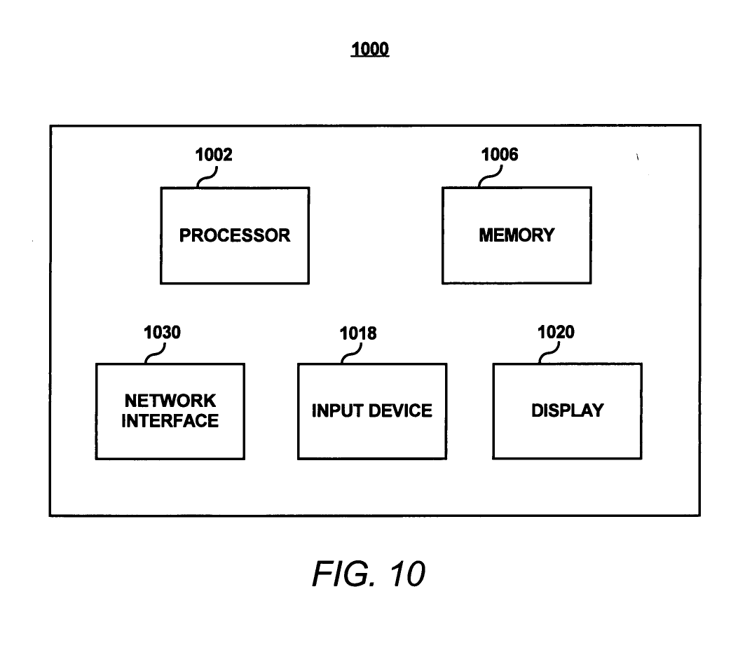

Referring to FIG. 10, and also with reference to FIG. 1, a schematic diagram of a computer system 1000 is shown in accordance with an embodiment. The computer system 1000 shown may be used as a server 190A-190D in the system shown in FIG. 1, for example. The computer system 1000 may include one or more processors, such as processor 1002, providing an execution platform for executing software. The computer system 1000 also includes a memory 1006, which may include Random Access Memory (RAM) where software is resident during runtime. Other types of memory such as ROM (read only memory), EPROM (erasable, programmable ROM), EEPROM (electrically erasable, programmable ROM) and data storage, such as hard disks, etc., may be used.

A user interfaces with the computer system 1000 with one or more input devices 1018, such as a keyboard, a mouse, a stylus, and the like and a display 1020. A network interface 1030 is provided for communicating with other computer systems. It will be apparent to one of ordinary skill in the art that FIG. 10 is meant to illustrate a generic computer system. Any type of computer system may be used. One or more components of the components of the computer system 1000 are optional, such as the display and input devices, and other types of components may be used or substituted as is known in the art.

One or more of the steps of the operations of the embodiments shown in FIG. 7 or FIG. 8, for example, may be implemented as software embedded on a computer readable medium, such as the memory 1006, and executed by the processor 1002. The steps may be embodied by a computer program, which may exist in a variety of forms both active and inactive. For example, there may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

What has been described and illustrated herein are embodiments along with some variations. While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. An advertisement, comprising:
a plurality of features; and
a plurality of machine readable feature identifications, each feature being associated with at least one of the plurality of machine readable feature identifications.

2. The advertisement of claim 1, further comprising a plurality of radio frequency identification tags storing the plurality of machine readable feature identifications.

3. The advertisement of claim 2, wherein the plurality of radio frequency identification tags store a plurality of EPC codes.

4. The advertisement of claim 1, wherein the plurality of machine readable feature identifications comprise at least one UPC symbol.

5. The advertisement of claim 1, further comprising a plurality of bar codes including the plurality of machine readable feature identifications.

6. The advertisement of claim 1, wherein the advertisement comprises at least one of a printed advertisement and an electronic advertisement.

7. A method of collecting data associated with an advertisement, said method comprising:
receiving a feature identification associated with a feature of an advertisement; and
creating a record including the feature identification and information associated with the feature identification.

8. The method of claim 7, wherein receiving the feature identification further comprises receiving a unique identification of the feature of the advertisement.

9. The method of claim 8, further comprising reading the feature identification from a radio frequency identification tag.

10. The method of claim 7, wherein receiving the feature identification further comprises receiving a feature identification associated with at least one of a feature of a printed advertisement and a feature of an electronic advertisement.

11. The method of claim 7, wherein receiving the feature identification further comprises receiving at least one of a UPC symbol and an Electronic Product Code.

12. The method of claim 7, further comprising tracking at least one segment of people who read the feature of the advertisement.

13. The method of claim 7, wherein receiving the feature identification further comprises receiving a feature identification associated with one of a plurality of features of the advertisement.

14. The method of claim 7, further comprising evaluating the effectiveness of the advertisement.

15. The method of claim 7, further comprising receiving information associated with a user identification.

16. A method of providing information about a specific feature of an advertisement, comprising:
identifying information associated with a feature identification, wherein the feature identification identifies a feature of a plurality of features for an advertisement; and
transmitting the information associated with the feature identification.

17. The method of claim 16, wherein identifying information further comprises identifying information associated with a unique identification of the feature of the advertisement.

18. The method of claim 16, further comprising reading the feature identification from a radio frequency identification tag.

19. The method of claim 16, further comprising reading the feature identification from a Uniform Product Code.

20. The method of claim 16, wherein identifying information associated with a feature identification comprises identifying information based on user preferences.

21. The method of claim 16, further comprising receiving a request from a user device including a request for information associated with the feature identification.

22. The method of claim 21, further comprising transmitting the associated information to the user device.

23. The method of claim 22, wherein transmitting the associated information to the user device further comprises transmitting the associated information to a device equipped with a reader operable to read the feature identification.

24. The method of claim 23, wherein transmitting the associated information to the user device further comprises transmitting the associated information to at least one of a cellular phone and a personal digital assistant.

25. The method of claim 16, further comprising:
identifying at least one selection criteria;
determining the associated information to transmit using the at least one selection criteria; and
transmitting the associated information.

26. The method of claim 25, wherein determining the associated information to transmit using the at least one selection criteria further comprises:
identifying a threshold of the at least one selection criteria; and
selecting an amount of data such that the threshold is not exceeded.

27. The method of claim 25, wherein determining the associated information to transmit using the at least one selection criteria further comprises:
determining an amount of the associated information to transmit based on predetermined user preferences.

28. The method of claim 16, further comprising:
identifying at least one customization parameter;
determining the associated information to transmit using the at least one customization parameter; and
transmitting the associated information.

29. The method of claim 28, wherein identifying at least one customization parameter further comprises identifying information about at least one user based on customer-relationship management.

30. The method of claim 16, further comprising tracking at least one segment of people who read the feature of the advertisement.

31. A computer system for collecting feature-specific information associated with an advertisement, comprising:
means for identifying information associated with a feature identification, wherein the feature identification identifies a feature of a plurality of features for an advertisement; and
means for transmitting the information associated with the feature identification.

32. A method of determining an effectiveness of an advertisement including a plurality of features, comprising:
collecting information associated with each event in which a feature identification was read, wherein the feature identification is associated with a feature of an advertisement;
analyzing the information collected; and
determining an effectiveness of the advertisement based on the analyzing of the information collected.

33. The method of claim 32, wherein collecting information associated with each event in which the feature identification was read further comprises:
receiving a user identification associated with each event in which the feature identification was read.

34. The method of claim 32, wherein collecting information associated with each event in which the feature identification was read further comprises:
identifying at least one of a user who read the feature identification, a specific time that the feature identification was read, and other event-specific information associated with each event in which the feature identification was read.

35. The method of claim 32, wherein collecting information associated with each event in which the feature identification was read further comprises:
receiving a unique identification of the feature of the advertisement.

36. The method of claim 35, further comprising reading the feature identification from a radio frequency identification tag.

37. The method of claim 32, wherein the feature identification comprises at least one of a UPC symbol and an Electronic Product Code.

38. The method of claim 32, wherein analyzing the information collected further comprises:
quantizing the information collected; and
aggregating statistics based on the information collected.

39. A computer readable medium on which is embedded one or more computer programs, said one or more computer programs implementing a method of collecting data associated with an advertisement, the method comprising:
receiving information associated with a feature identification, wherein the feature identification is associated with a feature of an advertisement;
receiving information associated with a user identification; and
creating a record including the information associated with the feature identification and the user identification.
